(19) United States
(12) Patent Application Publication
(10) Pub. No.: US 2023/0237530 A1
(43) Pub. Date: Jul. 27, 2023

(54) ADVERTISEMENT MANAGEMENT APPARATUS FOR VEHICLE, ADVERTISEMENT MANAGEMENT METHOD FOR VEHICLE, AND STORAGE MEDIUM

(71) Applicant: TOYOTA JIDOSHA KABUSHIKI KAISHA, Aichi-ken (JP)

(72) Inventors: Takeo MORIAI, Nagakute-shi (JP); Masakazu SETOYAMA, Miyoshi-shi (JP); Teruo MORI, Ichinomiya-shi (JP); Takanobu HIRAKOSHI, Nagoya-shi (JP)

(21) Appl. No.: 17/982,388

(22) Filed: Nov. 7, 2022

(30) Foreign Application Priority Data
Jan. 21, 2022 (JP) 2022-008134

(51) Int. Cl. G06Q 30/02; G06V 20/58; G06V 40/20; G06V 40/16

(52) U.S. Cl. CPC G06Q 30/0265; G06V 20/58; G06V 40/20; G06V 40/176

(57) ABSTRACT

An advertisement management apparatus for a vehicle includes a processor. The processor acquires image information on a captured image around a vehicle having an outer surface on which advertisement information is displayable, and the processor detects a predetermined motion of a person around the vehicle from the image information thus acquired and estimates a reaction of the person to the advertisement information.

### CROSS-REFERENCE TO RELATED APPLICATION

This application claims priority to Japanese Patent Application No. 2022-008134 filed on Jan. 21, 2022, incorporated herein by reference in its entirety.

### BACKGROUND

### 1. Technical Field

The present disclosure relates to an advertisement management apparatus for a vehicle, an advertisement management method for a vehicle, and a storage medium.

### 2. Description of Related Art

Japanese Patent No. 5601423 (JP 5601423 B) describes an advertisement exhibition system in which a predetermined advertisement is displayed to an unspecified number of people, and a reward is determined based on changes in a sale result of an advertised product.

### SUMMARY

However, in an apparatus described in JP 5601423 B, an advertising effect is estimated based on the changes in the sale result of the advertised product. Accordingly, there is room for improvement to grasp a direct effect obtained by displaying the advertisement.

An object of the present disclosure is to provide an advertisement management apparatus for a vehicle, an advertisement management method for a vehicle, and a storage medium each of which can grasp a direct effect obtained by displaying an advertisement.

An advertisement management apparatus for a vehicle according to a first aspect includes a processor. The processor acquires image information on a captured image around a vehicle having an outer surface on which advertisement information is displayable. The processor detects a predetermined motion of a person around the vehicle from the image information thus acquired and estimates a reaction of the person to the advertisement information.

The advertisement management apparatus according to the first aspect acquires image information on a captured image around a vehicle having an outer surface on which advertisement information is displayable. Further, the advertisement management apparatus detects a predetermined motion of a person around the vehicle from the image information thus acquired. Then, the advertisement management apparatus estimates a reaction of the person to the advertisement information from the predetermined motion of the person. By estimating the reaction of the person to the advertisement information from the motion of the person around the vehicle on which the advertisement information is displayed, it is possible to directly grasp the reaction of the person that is obtained by displaying an advertisement.

An advertisement management apparatus for a vehicle according to a second aspect is configured as follows. That is, in the advertisement management apparatus in the first aspect, the processor may estimate the reaction of the person to the advertisement information by detecting a motion including a sightline direction of the person as the predetermined motion of the person around the vehicle.

In the advertisement management apparatus according to the second aspect, by detecting the sightline direction of the person around the vehicle, it is possible to estimate that the person is interested in a displayed advertisement when the person turns his or her eyes toward the advertisement, for example. Further, in a case where the person turns his or her eyes away from the displayed advertisement, for example, it is possible to estimate that the person is not interested in the advertisement.

An advertisement management apparatus for a vehicle according to a third aspect is configured as follows. That is, in the advertisement management apparatus in the second aspect, the processor may cause the advertisement information to be displayed to the sightline direction.

In the advertisement management apparatus according to the third aspect, by displaying the advertisement information to the sightline direction of the person, it is possible to effectively cause the person to turn his or her eyes toward the advertisement. Note that “to display the advertisement information to the sightline direction” as used herein is not limited to a configuration in which the position to display the advertisement is changed within the same vehicle but is a concept widely including a configuration in which the advertisement information is displayed on a vehicle present in the sightline direction by transmitting the advertisement information to vehicles that are present in a vicinal area and configured to display the advertisement information.

An advertisement management apparatus for a vehicle according to a fourth aspect is configured as follows. That is, in the advertisement management apparatus in any one of the first to third aspects, the processor may estimate the reaction of the person to the advertisement information by detecting a motion including a facial expression of the person as the predetermined motion of the person around the vehicle.

In the advertisement management apparatus according to the fourth aspect, by detecting the facial expression of the person, it is possible to improve the accuracy of the estimation more than a case where the reaction of the person is estimated only by the sightline direction of the person.

An advertisement management method for a vehicle according to a fifth aspect includes: acquiring image information on a captured image around a vehicle having an outer surface on which advertisement information is displayable; and detecting a predetermined motion of a person around the vehicle from the image information thus acquired and estimating a reaction of the person to the advertisement information.

A storage medium according to a sixth aspect stores a program causing a computer to execute the following processes: a process of acquiring image information on a captured image around a vehicle having an outer surface on which advertisement information is displayable; and a process of detecting a predetermined motion of a person around the vehicle from the image information thus acquired and estimating a reaction of the person to the advertisement information.

As described above, with the advertisement management apparatus, the advertisement management method, and the storage medium according to the present disclosure, it is possible to grasp a direct effect obtained by displaying an advertisement.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an overall configuration of a system according to an embodiment;

FIG. 2 is a block diagram illustrating a hardware configuration of an advertisement management apparatus for a vehicle according to the embodiment;

FIG. 3 is a block diagram illustrating a functional configuration of the advertisement management apparatus according to the embodiment;

FIG. 4 is a table illustrating the relationship between detected motion and degree of interest;

FIG. 5 is a sequence diagram illustrating an example of the procedure of a process to be executed the system according to the embodiment; and

FIG. 6 is a flowchart diagram illustrating an example of the procedure of a reaction estimation process in the embodiment.

### DETAILED DESCRIPTION OF EMBODIMENTS

A system S including an advertisement management apparatus 10 for a vehicle according to an embodiment will be described with reference to the drawings.

Overall Configuration

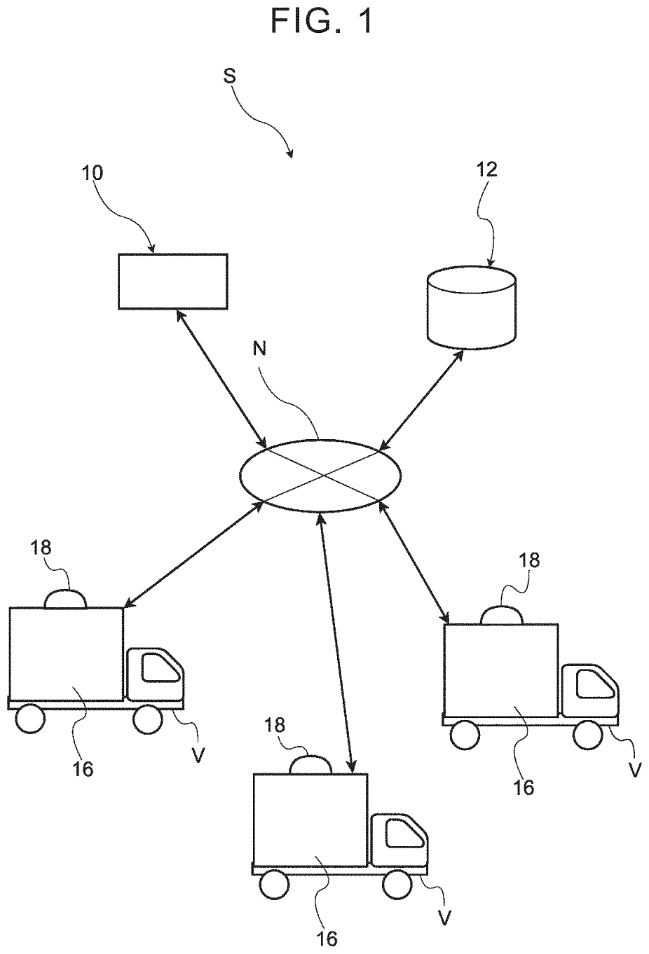

As illustrated in FIG. 1, the system S includes the advertisement management apparatus 10, a server 12, and a plurality of vehicles V. Further, the advertisement management apparatus 10, the server 12, and the vehicles V are communicable with each other via a network N. Note that three vehicles V are illustrated in FIG. 1 as an example. However, the present disclosure is not limited to this, and the system S may include four or more vehicles V. Further, the system S may include one or two vehicles V.

The server 12 is provided with a storage area (not illustrated), and data of advertisement information or the like to be displayed on the vehicles V, and so on are stored in the storage area. Further, data output from the advertisement management apparatus 10 is stored in the storage area of the server 12.

The vehicle V includes a display region 16 having an outer surface on which advertisement information can be displayed, and upon receipt of a signal from the advertisement management apparatus 10, predetermined advertisement information is displayed on the display region 16. In the present embodiment, as an example, the display region 16 of the vehicle V is set on each of three surfaces of a right side face, a left side face, and a rear face of a deck having a generally rectangular-solid shape. Further, the display region 16 is configured such that the display region 16 on one surface is dividable to display a plurality of pieces of advertisement information.

Further, the vehicle V is provided with a camera 18 configured to capture an image around the vehicle V. In the present embodiment, as an example, the camera 18 is provided on the deck so that the camera 18 can capture an image around the deck. Note that respective cameras may be provided on the three surfaces of the right side face, the left side face, and the rear face of the deck.

The system S is configured as described above, and the advertisement management apparatus 10 according to the present embodiment estimates a reaction of a person around the vehicle V to advertisement information based on image information on an image captured by the camera 18 in a state where the advertisement information is displayed on the display region 16 of the vehicle V.

Hardware Configuration of Advertisement Management Apparatus 10

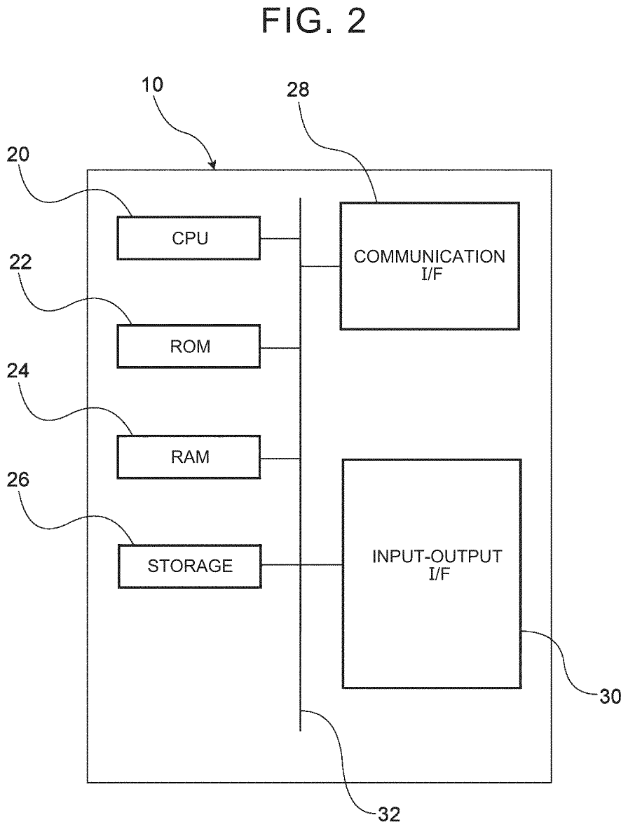

FIG. 2 is a block diagram illustrating a hardware configuration of the advertisement management apparatus. As illustrated in FIG. 2, the advertisement management apparatus 10 includes a central processing unit (CPU: a processor) 20, a read only memory (ROM) 22, a random access memory (RAM) 24, a storage 26, a communication interface (communication I/F) 28, and an input-output interface (input-output I/F) 30. Those constituents are connected to each other via a bus 32 in a mutually communicable manner.

The CPU 20 is a central processing unit and is configured to execute various programs and control each portion. That is, the CPU 20 reads a program from the ROM 22 or the storage 26 and executes the program in the RAM 24 as a working area. Further, the CPU 20 is configured to perform a control on each constituent and various computing processes in accordance with the programs stored in the ROM 22 or the storage 26.

In the ROM 22, various programs and various pieces of data are stored. The RAM 24 is a non-transitory recording medium in which a program or data is temporarily stored as a working area. The storage 26 is a non-transitory recording medium constituted by a hard disk drive (HDD) or a solid state drive (SSD) such that various programs including an operating system and various pieces of data are stored therein. In the present embodiment, vehicle control programs to perform a motion detection process and a reaction estimation process, various pieces of data, and so on are stored in the storage 26.

The communication I/F 28 is an interface via which the advertisement management apparatus 10 communicates with the server 12 and other devices, and standards such as Controller Area Network (CAN), Ethernet (registered trademark), Long Term Evolution (LTE), Fiber Distributed Data Interface (FDDI), and Wi-Fi (registered trademark) are used.

The input-output I/F 30 is an interface via which the advertisement management apparatus 10 performs input and output operations on peripheral devices.

Functional Configuration of Advertisement Management Apparatus 10

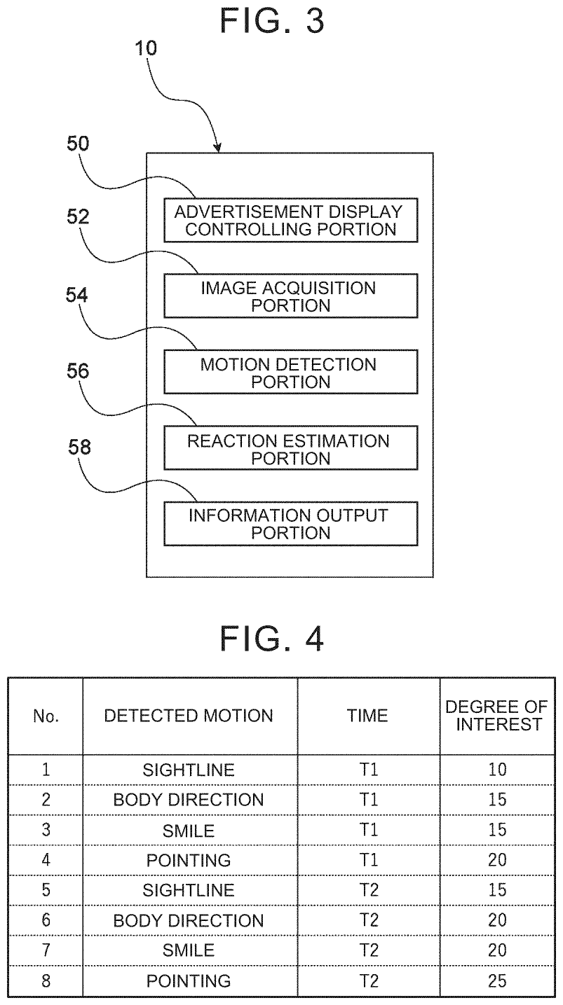

The advertisement management apparatus 10 implements various functions by use of the hardware resources illustrated in FIG. 2. Functional constituents implemented by the advertisement management apparatus 10 will be described with reference to FIG. 3.

As illustrated in FIG. 3, the advertisement management apparatus 10 includes, as the functional constituents, an advertisement display controlling portion 50, an image acquisition portion 52, a motion detection portion 54, a reaction estimation portion 56, and an information output portion 58. Note that the functional constituents are implemented such that the CPU 20 reads and executes a program stored in the ROM 22 or the storage 26.

The advertisement display controlling portion 50 causes the vehicle V to display advertisement information on the display region 16. More specifically, in a case where the advertisement display controlling portion 50 receives a signal to display an advertisement, the advertisement display controlling portion 50 acquires advertisement information from the server 12 and transmits the advertisement information to the vehicle V, so that the advertisement information is displayed on the display region 16.

Further, the advertisement display controlling portion 50 according to the present embodiment is configured to display the advertisement information to a sightline direction of a person detected by the motion detection portion 54 (described later). For example, in a case where the advertisement information is displayed on the display region 16 on the right side face of the vehicle V, when the sightline direction of a person around the vehicle V is directed toward the rear face of the vehicle V, the advertisement information is also displayed on the rear face. At this time, the advertisement information displayed on the right side face of the vehicle V may be deleted, or its displayed state may be maintained.

Further, in a case where a second vehicle V travels near the vehicle V on which the advertisement information is displayed, the advertisement display controlling portion 50 of the present embodiment may cause the second vehicle V to display the advertisement information on the display region 16 of the second vehicle V based on the sightline direction of the person around the vehicle V.

The image acquisition portion 52 acquires image information on a captured image around the vehicle V. More specifically, the image acquisition portion 52 acquires image information on an image captured by the camera 18 provided in the vehicle V. The image acquisition portion 52 may acquire the image information only while the vehicle V displays the advertisement information. Further, the image acquisition portion 52 may acquire regular image information regardless of the displayed state of the advertisement information.

The motion detection portion 54 detects a predetermined motion of a person around the vehicle V from the image information acquired by the image acquisition portion 52. More specifically, the motion detection portion 54 detects a motion of the person around the vehicle V that includes a sightline direction, a facial expression, a body direction, and a hand motion. For example, the motion detection portion 54 may detect the motion by performing pattern matching on the acquired image information. Further, for example, the motion detection portion 54 may detect the motion by inputting the acquired image information into a learned model subjected to machine learning in advance.

The reaction estimation portion 56 estimates a reaction of the person around the vehicle V to the advertisement information based on the action detected by the motion detection portion 54. In the present embodiment, as an example, the reaction estimation portion 56 evaluates a degree of interest to the advertisement information in a stepwise manner.

FIG. 4 is a table illustrating an example of the relationship between the motion of a person that is detected by the motion detection portion 54 and the degree of interest. As illustrated in FIG. 4, the degree of interest is set for each detected motion. Further, time T1 and time T2 indicate times during which a detected motion continues, and T2 is longer than T1.

Accordingly, in a case where the time when the person turns his or her eyes toward the display region 16 on which the advertisement information is displayed is between T1 and T2, the degree of interest is estimated to be 10. Further, in a case where the time when the person turns his or her eyes toward the display region 16 on which the advertisement information is displayed is T2 or more, the degree of interest is estimated to be 15. Note that, in a case where the time when the person turns his or her eyes toward the display region 16 is shorter than T1, no degree of interest is given. That is, it is estimated that the person is not interested in the advertisement information.

In a case where the time when the person turns his or her body toward the display region 16 on which the advertisement information is displayed is between T1 and T2, the degree of interest is estimated to be 15. Further, in a case where the time when the person turns his or her body toward the display region 16 on which the advertisement information is displayed is T2 or more, the degree of interest is estimated to be 20. Thus, the degree of interest in a case where the person turns his or her body toward the display region 16 is set to be higher than the degree of interest in a case where the person turns his or her eyes toward the display region 16.

Further, in a case where the time when the person around the vehicle V smiles is between T1 and T2, the degree of interest is estimated to be 15. Further, in a case where the time when the person smiles is T2 or more, the degree of interest is estimated to be 20. Regardless of the sightline direction and the body directions, the degree of interest is given in accordance with the time when the person smiles.

Further, in a case where the time when the person points toward the advertisement information is between T1 and T2, the degree of interest is estimated to be 20. Further, in a case where the time when the person points toward the advertisement information is T2 or more, the degree of interest is estimated to be 25.

Furthermore, in a case where both of No. 1 and No. 2 in FIG. 4 are detected, that is, in a case where the person turns his or her body and eyes toward the display region 16, the degree of interest is estimated to be 25 that is the sum of the degree of interest of No. 1 and the degree of interest of No. 2. Similarly, in a case where a plurality of motions is detected, the sum of respective degrees of interest of the motions is calculated.

The information output portion 58 illustrated in FIG. 3 outputs information based on the degree of interest for the advertisement information that is estimated by the reaction estimation portion 56. For example, the information output portion 58 outputs information on the age, the sex, and so on of a person who has a high degree of interest to the advertisement information.

Operation

Next will be described the operation of the present embodiment.

Example of Process

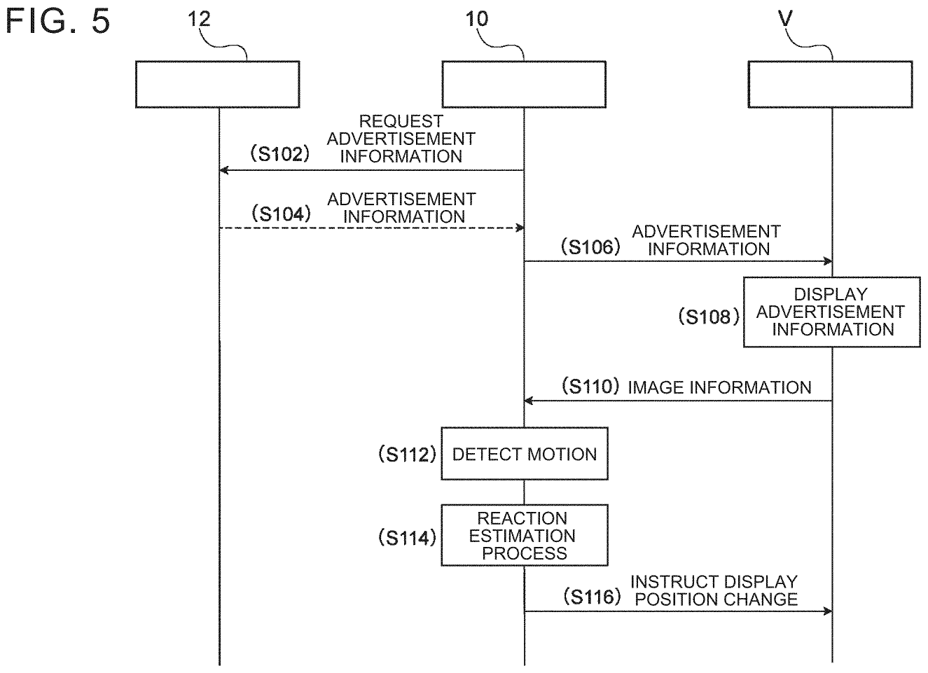

FIG. 5 is a sequence diagram illustrating an example of the procedure of a process of the system S according to the embodiment, and the following describes the advertisement management apparatus 10, the server 12, and the vehicle V.

In step S102 in FIG. 5, advertisement information is requested from the advertisement management apparatus 10 to the server 12, and the advertisement information to be displayed is transmitted from the server 12 in step S104.

In step S106, the advertisement management apparatus 10 transmits the advertisement information to the vehicle V by the function of the advertisement display controlling portion 50. Further, the advertisement management apparatus 10 instructs the vehicle V about the display region 16 on which an advertisement is to be displayed, display time, and so on.

In step S108, the advertisement information is displayed on the display region 16 of the vehicle V. Further, the vehicle V travels while an image around the vehicle V is captured by the camera 18.

In step S110, image information on the image captured by the camera 18 is transmitted from the vehicle V to the advertisement management apparatus 10.

In step S112, the advertisement management apparatus 10 detects, by the function of the motion detection portion 54, a predetermined motion of a person around the vehicle V based on the image information received from the vehicle V.

Subsequently, in step S114, the advertisement management apparatus 10 estimates, by the function of the reaction estimation portion 56, a reaction of the person around the vehicle V based on the motion detected by the motion detection portion 54. An example of the procedure of the reaction estimation process will be described later.

In step S116, the advertisement management apparatus 10 instructs the vehicle V to change the display position of the advertisement information. Step S116 is performed when the person around the vehicle V does not turn his or her eyes toward the advertisement information, based on the image information. More specifically, in step S116, the advertisement management apparatus 10 instructs, by the function of the advertisement display controlling portion 50, the vehicle V to perform a display position change of the advertisement information such that the advertisement information is displayed to the sightline direction of the person around the vehicle V. At this time, in a case where a second vehicle V travels near the vehicle V, the advertisement management apparatus 10 may instruct the second vehicle V to display the advertisement information on the display region 16 of the second vehicle V, based on the sightline direction of the person around the vehicle V.

Reaction Estimation Process

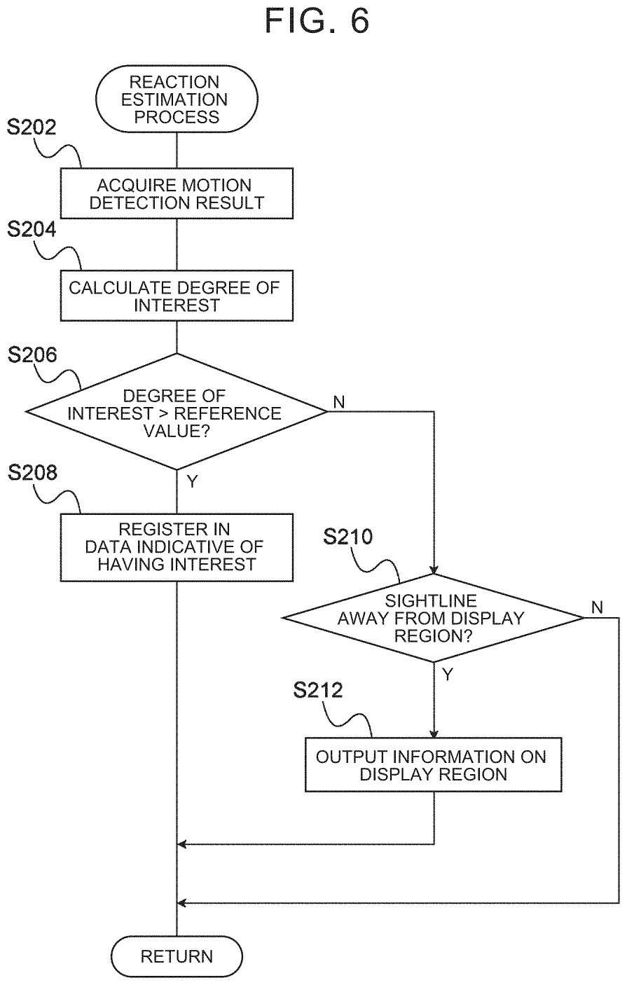

FIG. 6 is a flowchart illustrating an example of the procedure of the reaction estimation process to be executed by the advertisement management apparatus 10 according to the present embodiment. Note that the reaction estimation process is executed such that the CPU 20 reads a program from the storage 26 and executes the program by developing the program in the RAM 24.

As illustrated in FIG. 6, the CPU 20 acquires a motion detection result by the function of the motion detection portion 54 in step S202. Further, the CPU 20 calculates a degree of interest in step S204. More specifically, the CPU 20 calculates a degree of interest from a detected motion of a person and the table illustrated in FIG. 4.

The CPU 20 determines, in step S206, whether or not the degree of interest is larger than a predetermined reference value. The reference value is a value determined in advance and is set to a value based on which a person can be estimated to be interested in the advertisement information when the degree of interest is larger than the reference value. Further, the reference value may be changed depending on an area where the advertisement information is displayed, time to display the advertisement information, and the like.

When the CPU 20 determines that the degree of interest it is larger than the reference value in step S206, the CPU 20 shifts to the process of step S208 and registers information in data indicative of having interest. More specifically, the CPU 20 stores, in the storage 26 or the server 12, information on the age, the sex, and so on of a person determined to have a degree of interest that is larger than the reference value. Further, the CPU 20 adds 1 to the number of people determined to be interested in the advertisement information and ends the reaction estimation process.

Note that the information on the age, the sex, and so on of the person may be estimated by performing pattern matching on the image information or may be estimated by inputting the image information into a learned model subjected to machine learning in advance.

In the meantime, when the CPU 20 determines that the degree of interest is equal to or less than the reference value in step S206, the CPU 20 shifts to the process of step S210 and determines whether or not the person turns his or her eyes away from the advertisement information. More specifically, the CPU 20 detects the sightline direction of the person based on the image information. In a case where the sightline direction is away from the advertisement information, the CPU 20 determines that the person turns his or her eyes away from the advertisement information, and the CPU 20 shifts to the process of step S212. Further, in a case where the sightline direction of the person is directed toward the advertisement information in step S210, a negative determination is made in step S210, and the CPU 20 ends the reaction estimation process.

In a case where an affirmative determination is made in step S210, the CPU 20 outputs information on the display region 16 in step S212. More specifically, the CPU 20 specifies a display region 16 present in the sightline direction of the person by detecting the sightline direction, and the CPU 20 outputs the information on the display region 16. Then, the CPU 20 ends the reaction estimation process.

Note that, in a case where no display region 16 is present in the sightline direction of the person in step S210, the CPU 20 outputs information on a display region 16 present at the position nearest from the sightline direction of the person.

As described above, the advertisement management apparatus 10 according to the present embodiment detects a predetermined motion of a person around the vehicle V from image information acquired by the vehicle V and estimates a reaction of the person to advertisement information from the predetermined motion of the person. By estimating the reaction to the advertisement information from the motion of the person around the vehicle V on which the advertisement information is displayed as such, it is possible to directly grasp the reaction of the person that is obtained by displaying an advertisement.

Further, in the present embodiment, by detecting the sightline direction of the person around the vehicle, it is possible to estimate that the person is interested in an advertisement displayed on the vehicle when the person turns his or her eyes toward the advertisement, for example. Further, in a case where the person turns his or her eyes away from the displayed advertisement, for example, it is possible to estimate that the person is not interested in the advertisement.

Further, in the present embodiment, by displaying the advertisement information on the display region 16 present in the sightline direction of the person, it is possible to effectively cause the person to turn his or her eyes toward the advertisement. Furthermore, in the present embodiment, by detecting a motion including the facial expression of the person, it is possible to improve the accuracy of the estimation more than a case where the reaction of the person is estimated only by the sightline direction of the person. For example, even in a case where the person turns his or her eyes toward the advertisement information, when the person has a stiff expression, it is possible to estimate that the person is not interested in the advertisement.

The advertisement management apparatus 10 according to the embodiment and modifications has been described above, but it is needless to say that the present disclosure can be carried out in various forms within a range that does not deviate from the gist of the present disclosure. For example, in the above embodiment, an image around the vehicle V is captured by the camera 18, and the motion of a person around the vehicle V is detected based on image information on the captured image. However, the present disclosure is not limited to this. Instead of the camera 18 provided in the vehicle V, an image around the vehicle V may be captured by use of a flight vehicle such as a drone that moves around the vehicle V. Further, image information on an image captured by a fixed camera such as a security camera provided in a city area or the like may be used.

Further, in the above embodiment, as illustrated in FIG. 4, a degree of interest is set for each detected motion. However, the present disclosure is not limited to this. For example, in a case where a person turns his or her eyes toward advertisement information, the person may be estimated to be interested in the advertisement information. Further, for example, in a case where a person turns his or her body toward advertisement information, the person may be estimated to be interested in the advertisement information. In this case, whether or not the person around the vehicle V is interested in the advertisement information is estimated only by detecting the direction of the body of the person. Accordingly, it is possible to reduce a burden of image processing.

Further, in the above embodiment, advertisement information is displayed to the sightline direction of a person detected by the motion detection portion 54. However, the present disclosure is not limited to this. For example, in a case where the sightline direction of the person is away from the advertisement information, the type of an advertisement to be displayed may be changed.

Furthermore, various processors except the CPU 20 may execute the processes executed by the CPU 20 by reading the programs in the above embodiment. Examples of the processors in this case include Programmable Logic Device (PLD) such as Field-Programmable Gate Array (FPGA) the circuit configuration of which is changeable after manufacture, an exclusive electric circuit such as Application Specific Integrated Circuit (ASIC) as a processor having a circuit configuration designed for exclusive use of executing a specific process, and so on. Further, each process may be executed by one of these various processors or may be executed by a combination of two or more processors of the same type or different types, and for example, each process may be executed by a plurality of FPGAs, a combination of a CPU and an FPGA, or the like. Further, hardware structures of these various processors are electric circuits obtained by combining circuit elements such as semiconductor elements, more specifically.

Further, in the above embodiment, each program is stored (installed) in advance in a computer-readable non-transitory recording medium. However, the present disclosure is not limited to this. Each program may be provided by a non-transitory recording medium such as a compact disc read only memory (CD-ROM), a digital versatile disc read only memory (DVD-ROM), or a universal serial bus (USB) memory. Further, the program may be downloaded from an external device via a network.

Further, the procedures of the processes described in the embodiment are just examples, and an unnecessary step may be deleted, a new step may be added, or orders of the processes may be changed within a range that does not deviate from the gist of the present disclosure.

What is claimed is:

1. An advertisement management apparatus for a vehicle, comprising a processor, wherein:
the processor acquires image information on a captured image around a vehicle having an outer surface on which advertisement information is displayable; and
the processor detects a predetermined motion of a person around the vehicle from the image information thus acquired and estimates a reaction of the person to the advertisement information.

2. The advertisement management apparatus according to claim 1, wherein the processor estimates the reaction of the person to the advertisement information by detecting a motion including a sightline direction of the person as the predetermined motion of the person around the vehicle.

3. The advertisement management apparatus according to claim 2, wherein the processor causes the advertisement information to be displayed to the sightline direction.

4. The advertisement management apparatus according to claim 1, wherein the processor estimates the reaction of the person to the advertisement information by detecting a motion including a facial expression of the person as the predetermined motion of the person around the vehicle.

5. An advertisement management method for a vehicle, comprising:
acquiring image information on a captured image around a vehicle having an outer surface on which advertisement information is displayable; and
detecting a predetermined motion of a person around the vehicle from the image information thus acquired and estimating a reaction of the person to the advertisement information.

6. A non-transitory storage medium storing a program causing a computer to execute the following processes:
a process of acquiring image information on a captured image around a vehicle having an outer surface on which advertisement information is displayable; and
a process of detecting a predetermined motion of a person around the vehicle from the image information thus acquired and estimating a reaction of the person to the advertisement information.
